(19) United States
(12) Patent Application Publication
(10) Pub. No.: US 2005/0251597 A1
(43) Pub. Date: Nov. 10, 2005

(54) Wireless Smart Hard-Disk Drive

(76) Inventor: Guobiao Zhang, Stateline, NV (US)

Correspondence Address: GUOBIAO ZHANG, P.O. BOX 6182, STATELINE, NV, 89449-6182, US

(21) Appl. No.: 10/908,383

(22) Filed: May 10, 2005

Related U.S. Application Data
(60) Provisional application No. 60/579,071, filed on Jun. 12, 2004.
(60) Provisional application No. 60/579,725, filed on Jun. 14, 2004.
(60) Provisional application No. 60/585,123, filed on Jul. 2, 2004.
(60) Provisional application No. 60/586,129, filed on Jul. 7, 2004.
(60) Provisional application No. 60/640,901, filed on Jan. 1, 2005.
(60) Provisional application No. 60/593,396, filed on Jan. 11, 2005.

(30) Foreign Application Priority Data
May 10, 2004 (CN) 200410022482.7
Jun. 1, 2004 (CN) 200410022672.9

(51) Int. Cl. G06F 13/12

(52) U.S. Cl. 710/74

(57) ABSTRACT

The present invention discloses a portable wireless smart hard-disk drive (wsHDD). It comprises a wireless direct communication means with associated multimedia devices. Short-range wireless means is a preferred communication means. To users, the wsHDD is more convenient and costs less. The wsHDD-cellular phone will become personal communication, computation and storage hub.

### CROSS-REFERENCE TO RELATED APPLICATIONS

This application relates to the following domestic applications:

1. Provisional Application Ser. No. 60/579,071, “Smart Hard-Disk Drive and Methods”, Filed Jun. 12, 2004;

2. Provisional Application Ser. No. 60/579,725, “Smart Hard-Disk Drive and Methods”, Filed Jun. 14, 2004;

3. Provisional Application Ser. No. 60/585,123, “Smart Hard-Disk Drive and Methods”, Filed Jul. 2, 2004;

4. Provisional Application Ser. No. 60/586,129, “Smart Hard-Disk Drive and Methods”, Filed Jul. 7, 2004;

5. Provisional Application Ser. No. 60/640,901, “HDD-Wireless Phone”, Filed Jan. 1, 2005;

6. Provisional Application Ser. No. 60/593,396, “Hard-Disk-Drive-Based Dual-Range Wireless Phone”, Filed Jan. 11, 2005;

and the following foreign applications:

1. China, P. R., Application Serial No. 200410022482.7, “Wireless Smart Hard-Disk Drive”, Filed May 10, 2004;

2. China, P. R., Application Serial No. 200410022672.9, “Smart Hard-Disk Drive and Methods”, Filed Jun. 1, 2004.

### BACKGROUND

1. Technical Field of the Invention

The present invention relates to the field of electronic storage systems, more particularly to wireless smart hard-disk drive (wsHDD).

2. Prior Arts

Portable multimedia devices (hereinafter referred to as “multimedia device”, “device”) are portable devices that record and/or play multimedia (e.g. audio/video, i.e. A/V) information. They can be categorized into recording device, playing device and multi-function device. Recording device (RD) comprises at least a recording function, which converts external analog multimedia signals into multimedia data and records them onto a storage medium. Examples include digital still camera, digital camcorder, and digital voice recorder. Playing device (PD) comprises at least a playing function, which converts multimedia data into perceptible (analog) multimedia signals. Examples include audio player (e.g. MP3-player, CD player), movie player (e.g. VCD/DVD player, microdisplay-based video-player), portable game machine (e.g. GameBoy), and global positioning system (GPS). Multi-function devices (MD) comprise both recording and playing functions. Examples include personal versatile recorder (PVR), camera (or video) cellular phones with built-in MP3 player, and personal digital assistant (PDA).

Recently, the storage capacity of small form-factor (portable) hard-disk drive (HDD) increases tremendously: for 2.5″ HDD, it has reached 80GB; for 1.8″ HDD, 40GB (this number will soon reach 100 GB!). 40 GB is equivalent to ˜100 hours of MPEG4 movies; ˜20,000 5M Pixel photos; or, ˜10,000 MP3 songs. If it is used for only a single multimedia application, this huge capacity will be wasted (like in an ipod). Only when it is shared by a large number of multimedia devices, will the capacity of a portable HDD be fully exploited.

U.S. patent applications Ser. Nos. 10/685,887, 10/902,646 disclose a smart hard-disk drive (sHDD) 8 (FIGS. 1A-1B). It comprises a host function (e.g. USB host, or USB OTG) which enables direct data transfer between the sHDD and device. Because no computer is needed during data transfer, the sHDD 8 and associated multimedia devices 4 are highly portable. The sHDD can be shared by a number of multimedia devices (e.g. digital still camera 4r of FIG. 1A and MP3 player 4p of FIG. 1B) and therefore, is a universal multimedia storage platform.

The sHDD uses a wired communication means, i.e. a user needs to connect a wire 8w between the sHDD 8 and device 4 during data transfer. This user intervention can be inconvenient. Moreover, in order to store data acquired (or needed) between two data transfers, multimedia devices need certain amount of non-volatile memory as local storage. This raises the total system cost. Accordingly, the present invention discloses a wireless smart hard-disk drive (wsHDD). It keeps constant communication with multimedia devices using a wireless means. The wsHDD is more convenient and the total system cost can be lower.

### OBJECTS AND ADVANTAGES

It is a principle object of the present invention to provide a portable universal multimedia storage platform which does not require either computer or user intervention during data transfer—wireless smart hard-disk drive (wsHDD).

It is another object of the present invention to provide wireless multimedia devices associated with a wsHDD.

It is another object of the present invention to provide an interface-conversion apparatus which makes legacy multimedia devices compatible with a wsHDD.

In accordance with these and other objects of the present invention, wireless smart hard-disk drive (wsHDD) is disclosed.

### SUMMARY OF THE INVENTION

To address the storage needs of portable multimedia devices, the present invention discloses a portable wireless smart hard-disk drive (wsHDD). It comprises a wireless direct communication means with associated multimedia devices. Here, the word “wireless” means no user intervention is needed during data transfer, i.e. a user does not need to connect a wire between the wsHDD and device; the word “direct” means no computer is needed as intermediary during data transfer. With a huge storage capacity, a single portable wsHDD can store multimedia files for a large number of multimedia devices. Namely, wsHDD will become a universal multimedia storage platform. It can replace various storage media, such as removable flash cards (e.g. CF, MM, SD, MS, xD), videotapes (e.g. VHS, 8 mm, Hi8, MiniDV, MicroMV), and optical discs (e.g. CD, VCD, DVD).

To enable direct communication, either wsHDD or its associated devices need to comprise a wireless host function or a wireless peer-to-peer function. To fully implement direct communication, the wsHDD further needs to comprise a file-management means such as a file-management firmware. It can generate the cluster address based on the file information: when a recording device needs to store a file to the wsHDD, the file-management firmware will generate the wsHDD cluster addresses for this file; when a playing device needs to acquire a file from the wsHDD, the file-management firmware will produce the wsHDD cluster addresses of this file, with which the playing device can retrieve the needed clusters.

During usage, the distance between the wsHDD and device is small (e.g. ≦10 m, preferably ≦3 m). Namely, the wireless communication means is preferably a short-range wireless means. For short-range wireless means, fast speed, small power consumption and low cost can be easily achieved. Its examples include Bluetooth 2.0, ultrawide band (UWB), wireless USB (1.1, or 2.0), wireless 1394 and others.

The data-transfer process between the wsHDD and device is “transparent” to users. Thus, wsHDD is more convenient to users. Moreover, because frequent data transfer may occur between the wsHDD and device, the device buffer size can be significantly smaller than a conventional multimedia device, thus lowering the total system cost.

Besides storage function, wsHDD may comprise multimedia-processing functions, e.g. an MP3 playing function. A wsHDD may also comprise wired communication means, e.g. USB, IEEE 1394 and Ethernet. This is particularly useful for large-volume data transfer. Moreover, a wsHDD can also be a portion of a cellular phone. Cellular phones have become the de facto personal communication and computation hub. Combining with wsHDD, a cellular phone will become a personal storage hub as well. Accordingly, the present invention discloses a wsHDD-cellular phone. It comprises at least two wireless means: a short-range wireless means for communication with multimedia devices, and a long-range wireless means for regular cellular communication.

### BRIEF DESCRIPTION OF THE DRAWINGS

FIGS. 1A-1B illustrate a wired smart hard-disk drive (sHDD) and its usage models (prior arts);

FIGS. 2A-2B illustrate a preferred wireless smart hard-disk drive (wsHDD) and its usage models;

FIG. 3 illustrates the usage of a wsHDD as a universal multimedia storage platform;

FIGS. 4A-4B are two cross-sectional views of a preferred wsHDD; FIG. 4C illustrates a preferred wsHDD circuit block diagram; FIG. 4D illustrates a preferred wsHDD motherboard layout;

FIGS. 5A-5B illustrates two preferred wireless recording devices; FIG. 5C illustrates a preferred circuit block diagram of a wireless recording device;

FIG. 6A illustrates a first preferred wireless playing devices; FIGS. 6BA-6BB illustrate a second preferred wireless playing device; FIG. 6C illustrates a preferred circuit block diagram of a wireless playing device;

FIGS. 7AA-7CB illustrates preferred wireless data interfaces of three preferred wsHDD's and their associated wireless multimedia devices;

FIG. 8A illustrates preferred download and upload firmwares of a wsHDD; FIG. 8B illustrates a preferred file-management firmware of a wsHDD;

FIGS. 9A-9C illustrate usage models of a preferred hybrid smart hard-disk drives (hsHDD);

FIG. 10 illustrates a preferred circuit block diagram of an hsHDD;

FIG. 11 illustrates a preferred wsHDD with at least one multimedia-processing function;

FIGS. 12A-12D illustrate a preferred wsHDD-cellular phone;

FIGS. 13A-13B illustrate two usage models of a preferred wsHDD-cellular phone;

FIGS. 14A-14B illustrate preferred circuit block diagrams of a wsHDD-cellular phone;

FIGS. 15A-15C illustrate the structure, usage model and circuit block diagram of a preferred interface-conversion apparatus;

FIG. 16 illustrates a preferred driver-file management in a wsHDD.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention discloses a wireless smart hard-disk drive (wsHDD). It comprises a wireless direct communication means with associated multimedia devices. Here, the word “wireless” means no user intervention is needed during data transfer, i.e. a user does not need to connect a wire between the wsHDD and device; the word “direct” means no computer is needed as intermediary during data transfer. FIGS. 2A-2B illustrate the usage models of a preferred wsHDD 88. It can directly communicate with a wireless multimedia device 84 (e.g. a wireless recording device 84r or a wireless playing device 84p) using a wireless means 88wI. Because this data-transfer process is “transparent” to users, the wsHDD is convenient. Moreover, because frequent data transfer may occur between the wsHDD and device, the device buffer size can be significantly smaller than a conventional device, thus lowering the total system cost.

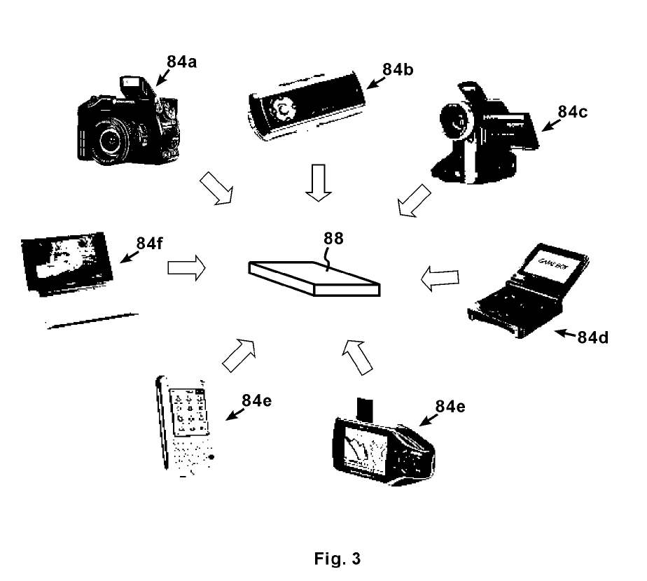

The present invention addresses the storage needs of portable multimedia devices. Naturally, the wsHDD should be based on small form-factor (i.e. portable) hard-disk drive (HDD). Recently, the storage capacity of portable HDD increases tremendously: for 2.5″ HDD, it has reached 80GB; for 1.8″ HDD, 40 GB (this number will soon reach 100 GB!). 40 GB is equivalent to ˜100 hours of MPEG4 movies; ˜20,000 5M Pixel photos; or, ˜10,000 MP3 songs. If it is used for only a single multimedia application, this huge capacity will be wasted (like in an ipod). Only when it is shared by a large number of multimedia devices, will the capacity of a wsHDD 88 be fully exploited. Examples of multimedia devices include digital camera 84a, MP3 player 84b, digital camcorder 84c, portable game machine 84d (e.g. Nintendo's DS), global position system (GPS) 84e, digital personal assistant (DPA) 84e, and portable movie player 84f (FIG. 3). Accordingly, the wsHDD 88 will become a universal multimedia storage platform. It can replace various storage media, such as removable flash cards (e.g. CF, MM, SD, MS, xD), videotapes (e.g. VHS, 8 mm, Hi8, MiniDV, MicroMV), and optical discs (e.g. CD, VCD, DVD).

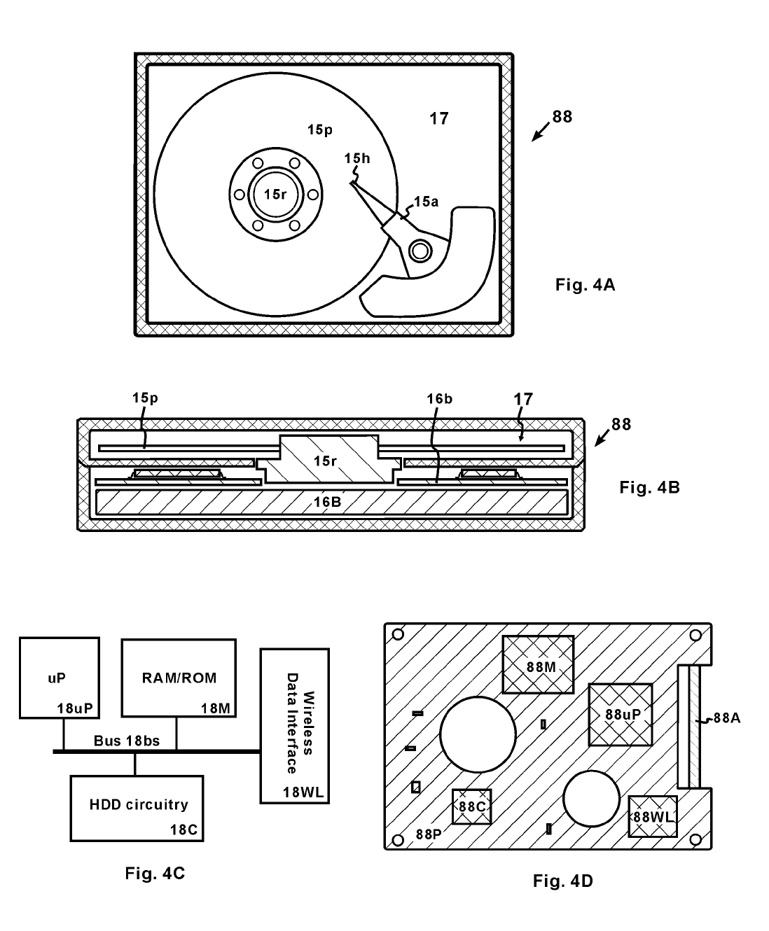

FIGS. 4A-4B are cross-sectional views of the wsHDD along two directions. FIG. 4A is its cross-sectional view from the top (with top panel lifted). It comprises a head-disk assembly (HDA) 17, which includes at least one platter 15p, rotor 15r, head 15h and arm 15a. For small form-factor (portable) HDD, its platter diameter is preferably no larger than 2.5″. FIG. 4B is its cross-sectional view from the front (with front panel removed). It comprises HDA 17, PCB 16b, and battery 16B. Battery 16B provides power to the wsHDD 88. The HDA 17 is a major component of a wsHDD 88. Its volume can be used as a gauge to measure the wsHDD volume. To ensure an acceptable portability, the volume ratio R, defined as,
R=[(Volume of wsHDD 88)−(Volume of battery 16B)]/(Volume of HDA 17) is preferably no larger than 5. A reasonable R value is ˜2-3.

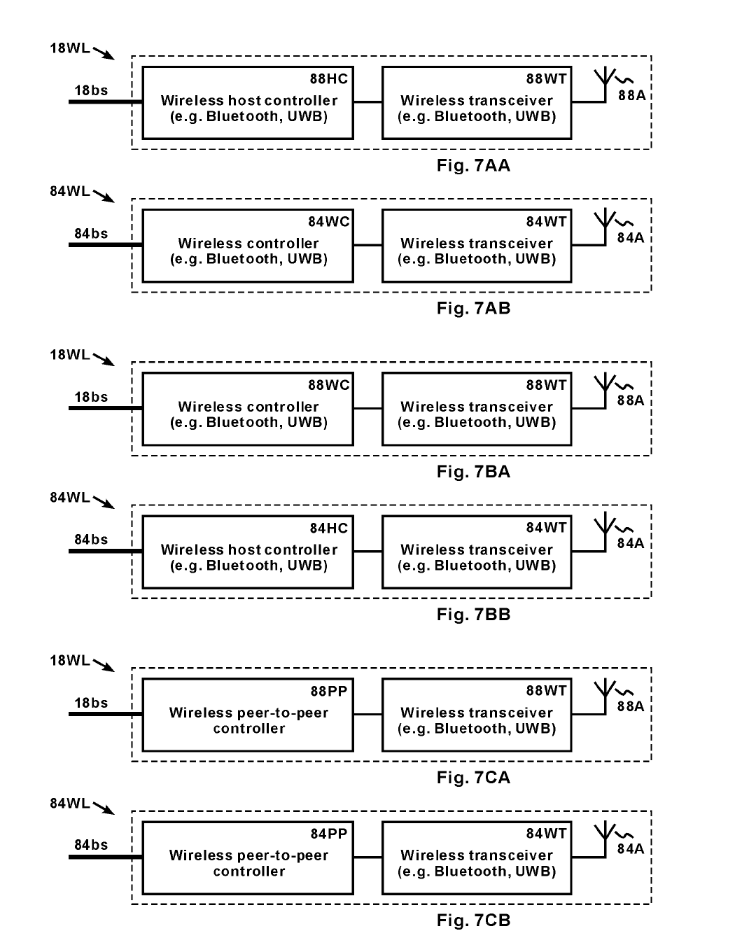

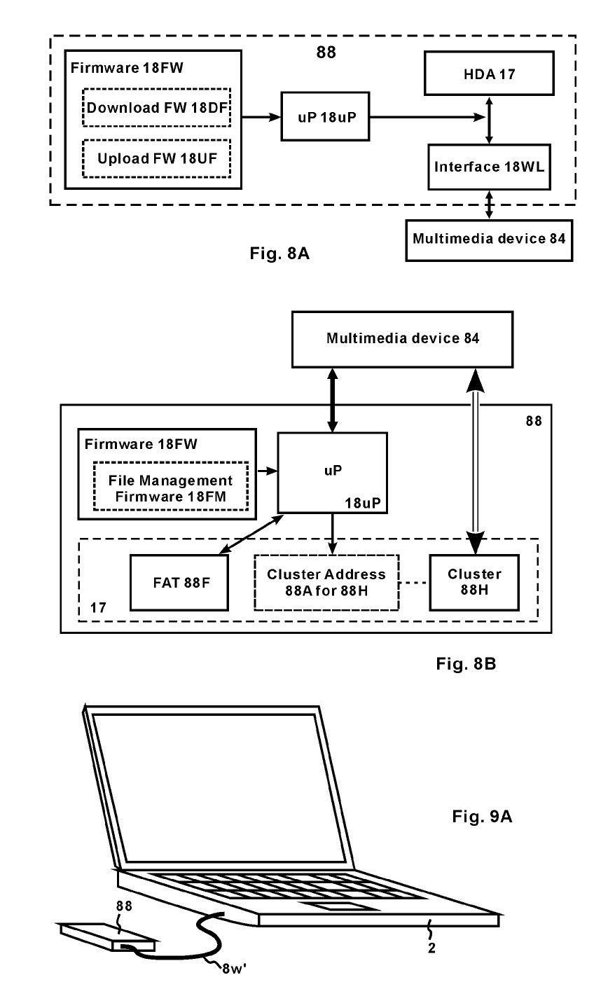

FIG. 4C is a preferred circuit block diagram of a wsHDD. It comprises a microprocessor (uP) 18uP, system memory (including RAM and ROM) 18M, HDD circuitry 18C and wireless data interface 18WL. These blocks communicate through the system bus 18bs. The uP 18uP provides “intelligence” to the wsHDD. The RAM acts as a buffer for the wsHDD. Its capacity is large enough to enable “intermittent access”: during read, a large amount of data are read out once from the HDA and stored in the buffer, which allows the HDA to be switched into standby while data are read out piecewise; during write, data are only written to the buffer until it is almost full, when the HDA is turned on and all data in the buffer are written to the HDA once. The ROM stores firmware for the wsHDD (referring to FIGS. 8A-8B). For those skilled in the art, the HDD circuitry 18C include HDD controller, servo circuit and read channel. Wireless data interface 18WL provides communication channel between the wsHDD and the wireless multimedia devices (referring to FIGS. 7AA-7CB).

FIG. 4D is a preferred motherboard layout of a wsHDD. In order to lower the total system cost, an “HDD integration” method is used (referring to U.S. patent application Ser. No. 10/902,646, “Smart Hard-Disk Drive”, Filed Jul. 28, 2004, by the same inventor). According to this method, some HDD IC 88C (e.g. HDD controller, servo, and read channel) is integrated on the same motherboard 88P as other system ICs (e.g. uP IC 88uP, memory IC 88M and wireless data interface IC 88WL). The “HDD integration” can lower the total system cost and improve the data-transfer speed.

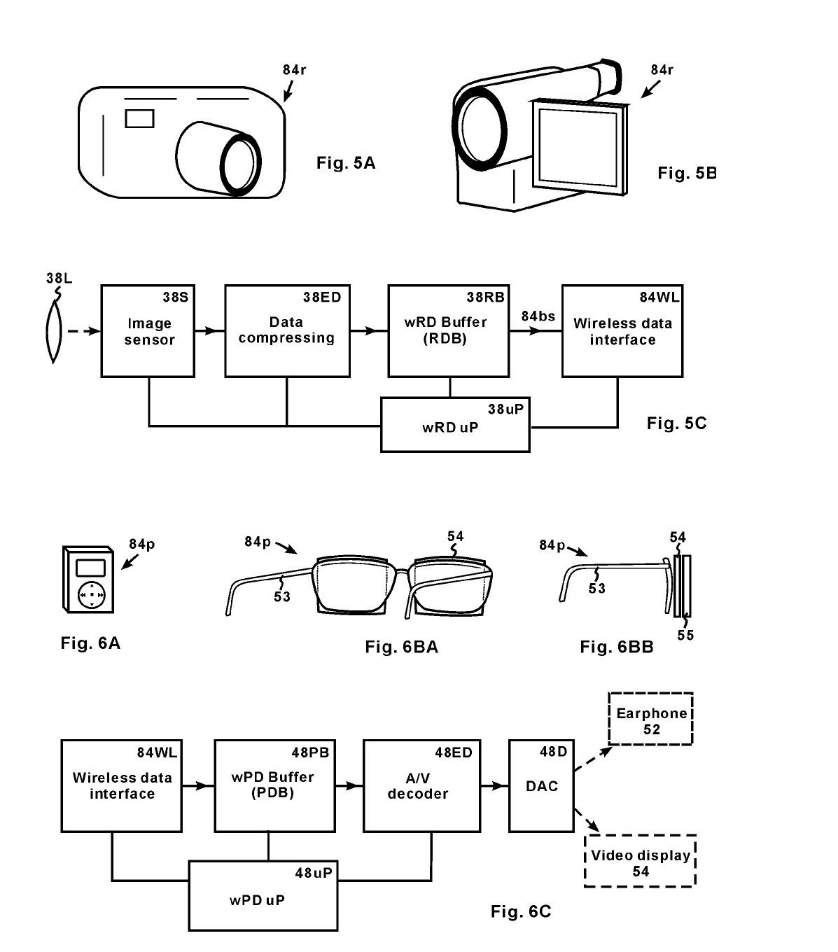

FIGS. 5A-5C illustrate two preferred wireless recording device (wRD) 84r and their circuit block diagram. The wireless digital camera (FIG. 5A) and wireless digital camcorder (FIG. 5B) can both transfer the captured still or motion images to an wsHDD through a wireless means. FIG. 5C is a preferred circuit block diagram for these wRD's. It comprises a lens 38L, wRD uP 38uP, image sensor 38S, data compressing block 38ED, wRD buffer (RDB) 38RB and wireless data interface 38WL. Lens 38L and image sensor 38S captures still or motion images and converts them into digital signals; data compressing block 38ED converts these digital signals into multimedia data, which are temporarily stored in RDB 38MB; wireless data interface 38WL provides data communication channel between the wsHDD 88 and wRD 84r. Apparently, the circuit block diagram of FIG. 5C can also be used in other wRD's, e.g. digital voice recorder.

FIGS. 6A-6BB illustrate two preferred wireless playing device (wPD) 84p. The preferred wireless MP3 player in FIG. 6A can receive multimedia data from a wsHDD 88 through a wireless means. FIGS. 6BA-6BB illustrates a preferred microdisplay-based wPD: FIG. 6BA is its perspective view; FIG. 6BB is a side view. This wPD uses microdisplay chips 54, which are mounted on an eyeglass (or goggle) structure 53 (with other electronics 55). Microdisplay is a mature technology (e.g. see Wright et al. “Die-sized displays enable new applications”, Semiconductor International, Sep. 1998). Microdisplay can form images to a viewer similar in quality and size to conventional displays (e.g. portable video/movie player), while being much lighter in weight and smaller in size. The microdisplay-based playing devices (wireless or wired) will make a revolutionary change to the movie-watching experience, as MP3 player did to the music-listening experience. The inventor believes that microdisplay-based video/movie display will have great market potential.

FIG. 6C is a preferred circuit block diagram for the wPD's. It comprises a wireless data interface 48WL, wPD uP 48uP, wPD buffer (PDB) 48PB, A/V decoder 48ED, D/A converter 48D, and output devices (e.g. earphone 52, or video display 54). The wireless data interface 48WL provides communication channel between the wsHDD 88 and wPD 84p. The PDB 48PB temporarily stores multimedia data sent through wireless data interface 48WL. The A/V decoder 48ED decodes these multimedia data and the D/A converter 48D further converts them into analog signals. For audio signals, they are sent to earphone 52; for video signals, they are sent to video display 54. Apparently, the circuit block diagram of FIG. 6C can be used in other wPD's, e.g. digital audio player, digital video player, portable game machine, GPS, PVR, cellular phones and PDA.

To enable direct communication, either wsHDD or its associated multimedia devices need to comprise a wireless host function or a wireless peer-to-peer function. FIGS. 7AA-7CB illustrates three preferred wireless data interfaces. In the preferred embodiments of FIGS. 7AA-7AB, the wsHDD 88 acts as host (master) and comprises an antenna 88A, a wireless transceiver 88WT and a wireless host controller 88HC (FIG. 7AA); the wireless multimedia device 84 acts as device (slave) and comprises an antenna 84A, a wireless transceiver 84WT, and a wireless controller 84WC (FIG. 7AB). Here, the wsHDD 88 issues data-transfer commands. The preferred embodiments of FIGS. 7BA-7BB differ from FIGS. 7AA-7AB in that the wsHDD 88 acts as device (slave) and the wireless multimedia device 84 acts as host (master). Here, the wireless multimedia device 84 issues data-transfer commands. In the preferred embodiments of FIGS. 7CA-7CB, peer-to-peer wireless communication is used. Both the wsHDD 88 and the wireless device 84 have a wireless peer-to-peer controller 88PP, 84PP. Consequently, both of them can issue data-transfer commands.

During usage, the distance between the wsHDD and device is small (e.g. ≦10 m, preferably ≦3 m). Namely, the wireless communication means is preferably a short-range wireless means. For short-range wireless means, fast speed (e.g. ≧1 MByte/s), small power consumption and low cost can be easily achieved. Its examples include Bluetooth 2.0, ultrawide band (UWB), wireless USB (1.1, or 2.0), wireless 1394 and others.

Bluetooth is a mature technology. It is a short-range, low-power and low-cost wireless technology. Its transfer speed is: eBluetooth 1.1-0.7 Mb/s, Bluetooth 1.2-0.7˜2.1 Mb/s, Bluetooth 2.0-3.8˜11.4 Mb/s. Bluetooth 2.0 is suitable for wsHDD. On the other hand, wireless USB is a short-range, low-power, low-cost and high-speed (up to ˜480 Mb/s) wireless technology. UWB (ultrawide band) is proposed as the PHY layer for wireless USB. For those skilled in the art, other existing and future short- or medium-range wireless technology (including wireless 1394, HomeRF, Zigbee, WiFi, WiMAX, IEEE 802.11, IEEE 802.15, IEEE 802.16) can also be used.

To fully implement direct communication, the wsHDD 88 further comprises a number of firmwares 18FW. As illustrated in FIG. 8A, a wsHDD 88 comprises a download firmware 18DF and/or a upload firmware 18UF. These firmwares control the file download and/or upload process. As illustrated in FIG. 8B, a wsHDD 88 further comprises a file-management firmware 18FM. It generates the cluster addresses 88A based on the file information: when a recording device 84 needs to store a file to the wsHDD 88, the file-management firmware will make an inquiry to the FAT table 88F and then generate the HDA addresses 88A of various clusters 88H for this file; when a playing device 84 needs to acquire a file from the wsHDD 88, the file-management firmware will make an inquiry to the FAT table 88F and then produce the HDA addresses 88A of various clusters 88H for this file, with which the playing device 84 can retrieve the needed clusters.

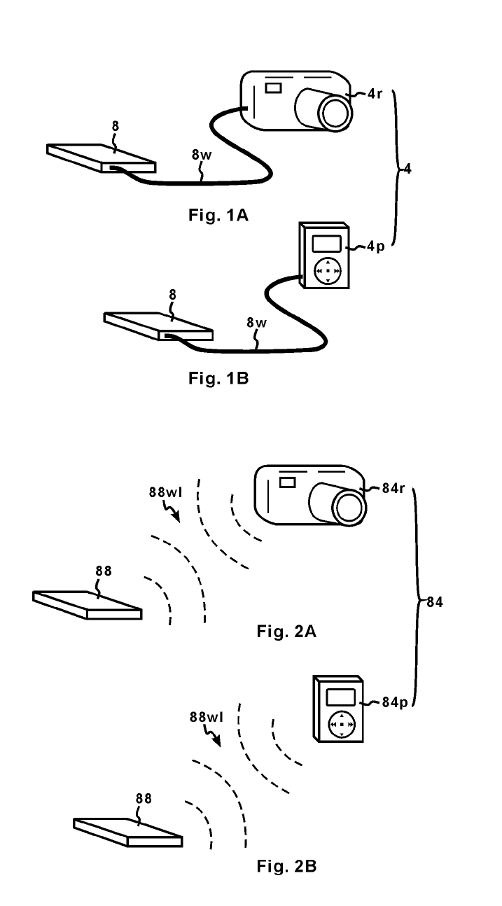

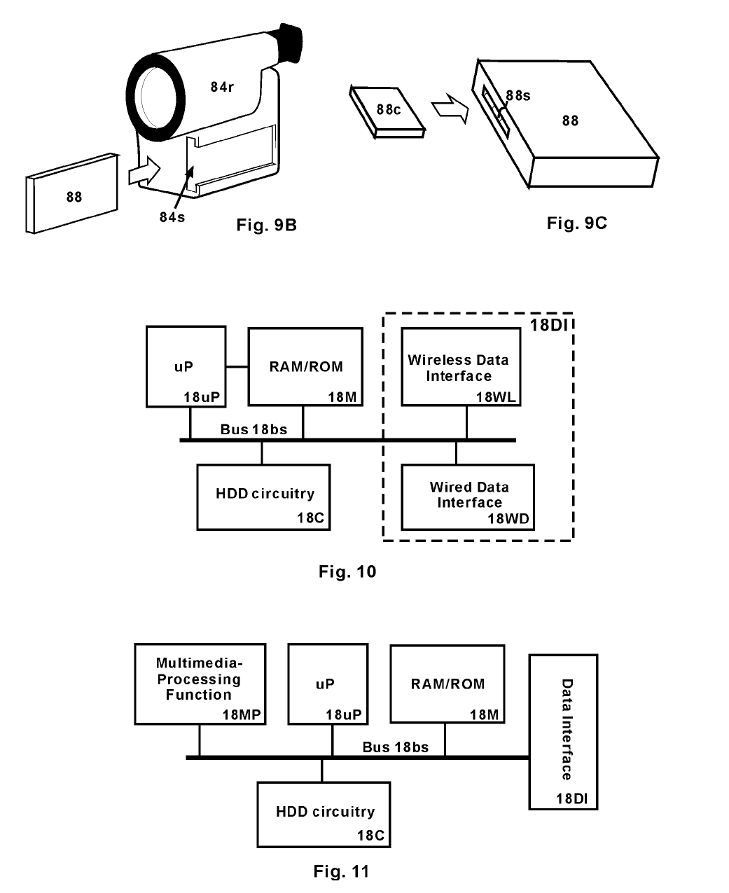

The wsHDD offers user convenience and lower total system cost. On the other hand, when a large amount of data (˜GB) needs to be transferred, wired communication is still necessary. Accordingly, the present invention discloses a hybrid smart hard-disk drive (hsHDD). It comprises both wireless and wired communication means. The usage model of the wireless means is similar to those disclosed in FIGS. 2A-2B. For the wired means, there are two types of usage models: A) data are directly transferred between the hsHDD and a multimedia device (FIGS. 9A-9B); or B) data are directly transferred between the hsHDD and a removable storage used by a multimedia device (FIG. 9C). In FIG. 9A, a wire 8w′ provides communication channel between the hsHDD and a computer 2 (or a multimedia device, as illustrated in Figs. 1A-1B). Examples of wired communication include USB, IEEE 1394 and Ethernet. In FIG. 9B, the multimedia device 84r (e.g. a digital camcorder) has a body large enough to hold the hsHDD 88. The hsHDD 88 is directly inserted into a slot 88s of the device 84r and establishes constant communication between them. In FIG. 9C, a card slot 88s is built into the hsHDD 88. The removable storage (e.g. a CF card) 88c can be inserted into said card slot 88s and initiate data transfer. Here, the removable storage could be any type of removable flash cards, such as CF, MM, SD, MS, and xD cards.

FIG. 10 illustrates a preferred circuit block diagram of an hsHDD. Compared with that of the wsHDD, its data interface block 18DI further comprises a wired data interface 18WD. Examples of wired data interface 18W include USB controller (for FIG. 9A), CF card controller (for FIG. 9C) and others.

Besides regular storage function, a wsHDD can have many other functions. In the preferred embodiment of FIG. 11, the wsHDD comprises at least one multimedia-processing function 18MP. Here, multimedia-processing function 18MP could be a recording function, a playing function, or both. For example, a wsHDD could also be an MP3 player, which plays the audio files stored thereon; it could have a built-in camera, which saves photos onto the wsHDD.

A wsHDD can also be a portion of a cellular phone. Cellular phones have become the de facto personal communication and computation hub. Combining with wsHDD, a cellular phone will become a personal storage hub as well. Accordingly, the present invention discloses a wsHDD-cellular phone. It comprises at least two wireless means: a short-range wireless means for communication with multimedia devices, and a long-range wireless means for regular cellular communication.

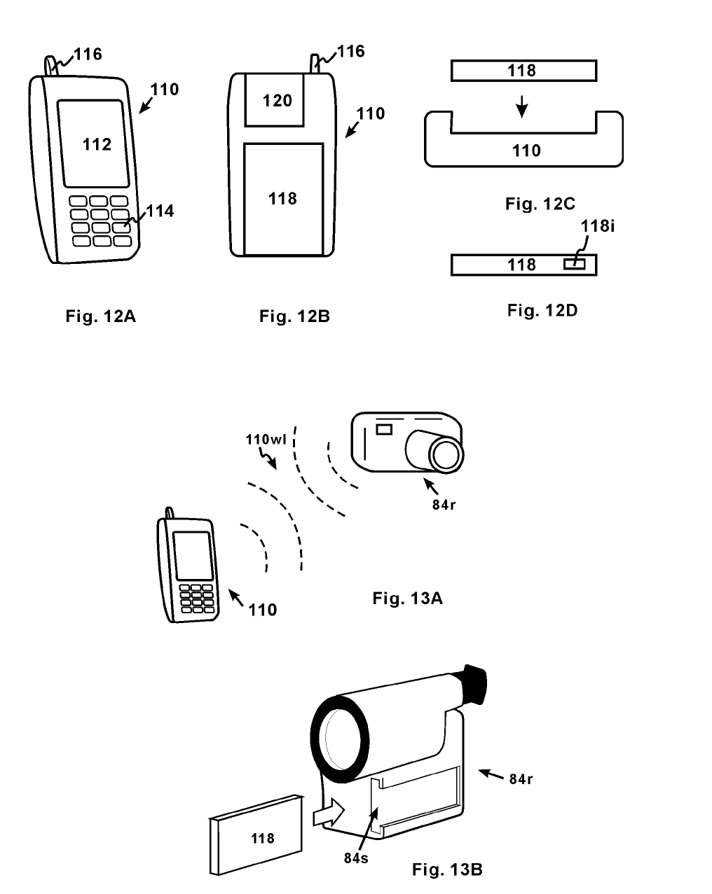

FIGS. 12A-12D illustrate various views of a preferred wsHDD-cellular phone 110. FIG. 12A is its front view. It comprises a display 112, input 114, and antenna 116. FIG. 12B is its back view. It further comprises an HDD 118 and a battery 120. Optionally, the HDD 118 can be detached from the phone 110. The reason for this will be explained in FIG. 13B. FIG. 12C is a side view from the tail end of the phone. Here, HDD 118 is detached from the phone 110. FIG. 12D is a side view of the HDD 118 from the head end of the phone. It comprises an HDD interface 118i. This interface 118i could be a wired data interface such as USB interface.

FIGS. 13A-13B illustrate two usage models of a preferred wsHDD-cellular phone. In FIG. 13A, the wsHDD-cellular phone can directly communicate with a digital camera 84r through a short-range wireless means. In FIG. 13B, the HDD 118 can be detached from the wsHDD-cellular phone 110 and directly inserted into a slot 84s of the digital camcorder 84. It can further establish constant communication with the digital camcorder 84 through the HDD interface 118i.

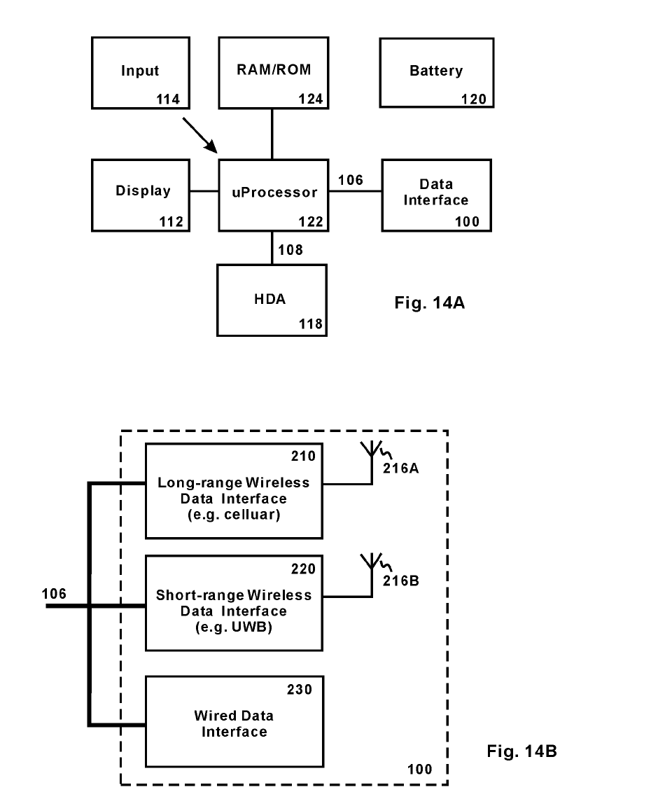

FIG. 14A illustrate a preferred circuit block diagram of a wsHDD-cellular phone 110. It is comprised of a microprocessor 122, system memory (RAM/ROM) 124, battery 120, display 112, input 114, HDD 118 and data interface 100. Data comes from the data interface 100 are transferred to the HDD 118 through interfaces 106, 108. FIG. 14B illustrates a preferred circuit block diagram of the data interface 100. It is comprised of a long-range wireless data interface 210, a short-range wireless data interface 220, and a wired data interface 230. The long-range wireless data interface 210 provides regular cellular function for the phone 110 through antenna 216A. The short-range wireless data interface 220 provides high-speed data-transfer capabilities between the phone 110 and devices 84 through antenna 216B. The wired data interface 230 provides wired data-transfer capabilities between the phone 110 and devices 84, which is suitable for large-volume data transfer.

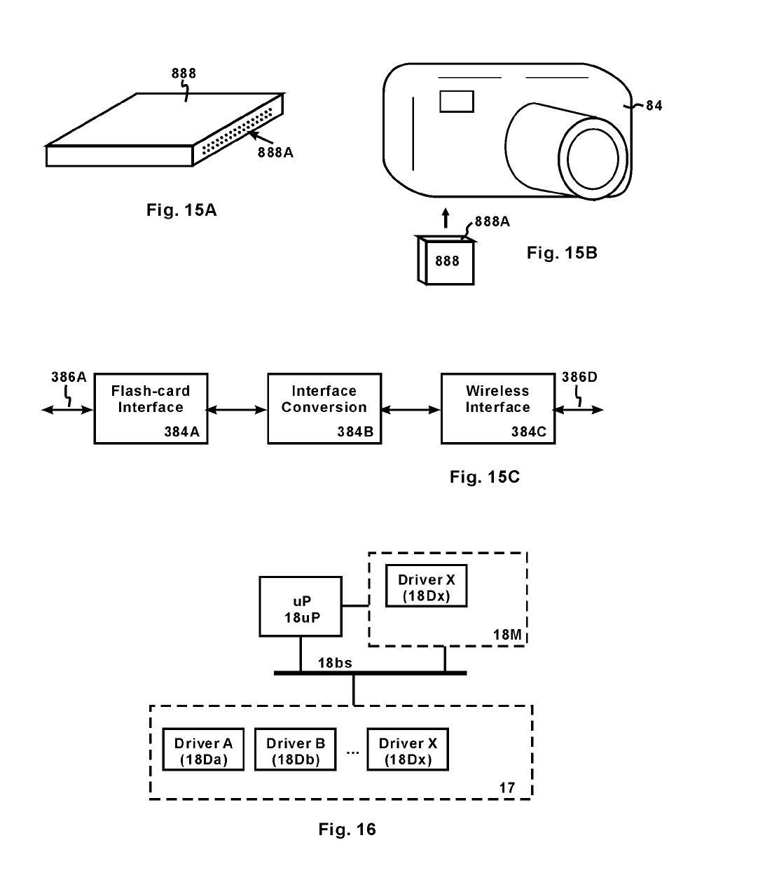

The present invention further discloses an interface-conversion apparatus that enables direct wireless communication between a wsHDD and a legacy multimedia device (i.e. prior-art multimedia devices without wireless capabilities). This interface-conversion apparatus has a form factor and interface similar to a conventional removable storage used in said legacy device. FIG. 15A illustrates a CF-card-like interface-conversion apparatus 888. It has the same form factor and interface 888A as a conventional CF card. After being inserted into the CF-card slot of a legacy digital still camera 84 (FIG. 15B), it can convert data from CF-format 386A to a wireless format 386D and send them to the wsHDD through a wireless means. It preferably comprises a flash-card interface 384A, an interface-conversion block 384B, and a wireless data interface 384C (FIG. 15C). Apparently, the interface-conversion apparatus could be removable-flash-card-like (e.g. CF, MM, SD, MS, xD . . . ) or videotape-like (e.g. VHS, 8 mm, Hi8, MiniDV, MicroMV . . . ).

To become a universal multimedia storage platform, a wsHDD needs to support a large number of multimedia devices. The drivers for these devices may require a large space. For conventional embedded-system design approach, these drivers are burnt into the system ROM. This is expensive and inflexible. To address these issues, the present invention proposes to store drivers (18Da, 18Db . . . 18Dx) in the HDA 17 and upload an appropriate one when needed (FIG. 16). To be more specific, after a device 84 is connected to the wsHDD 88, it is first recognized and then an appropriate driver 18Dx is uploaded from the HDA 17 to the system memory 18M. Apparently, this approach is more flexible and incurs a lower system cost.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

1. A wireless smart hard-disk drive, comprising:
a head-disk assembly for storing data for a multimedia device; and
a wireless direct communication means for transferring data between said head-disk assembly and said multimedia device.

2. The wireless smart hard-disk drive according to claim 1, further comprising a host function or a peer-to-peer function for enabling said direct communication means.

3. The wireless smart hard-disk drive according to claim 1, further comprising a file-management means for locally generating cluster address for said head-disk assembly.

4. The wireless smart hard-disk drive according to claim 1, further comprising:
a upload means for transferring data from said wsHDD to a multimedia device with at least a playing function; and
a download means for transferring data from a multimedia device with at least a recording function to said wsHDD.

5. The wireless smart hard-disk drive according to claim 1, wherein said wireless direct communication means is a short-range wireless means.

6. The wireless smart hard-disk drive according to claim 5, wherein said short-range wireless means has a range no longer than 10 meters.

7. The wireless smart hard-disk drive according to claim 1, wherein said wireless direct communication means is a high-speed wireless means.

8. The wireless smart hard-disk drive according to claim 1, wherein said wireless direct communication means is selected from a group of wireless means consisting of Bluetooth, wireless USB, wireless 1394, Ultrawide band, Zigbee, WiFi, WiMax, HomeRF, IEEE 802.11, IEEE 802.15, and IEEE 802.16.

9. The wireless smart hard-disk drive according to claim 1, further comprising a motherboard, wherein at least a portion of circuitry for said head-disk assembly and at least a portion of circuitry for said wireless means are located on said motherboard.

10. The wireless smart hard-disk drive according to claim 1, wherein said head-disk assembly has a platter diameter no larger than 2.5 inch.

11. The wireless smart hard-disk drive according to claim 1, wherein the volume ratio between said wsHDD excluding battery and said head-disk assembly is no larger than 5.

12. The wireless smart hard-disk drive according to claim 1, further comprising a wired direct communication means for transferring data between said head-disk assembly and a second multimedia device or a removable storage thereof.

13. The wireless smart hard-disk drive according to claim 12, wherein:
said wired communication means is selected from a group of wired means consisting of USB, IEEE 1394, and Ethernet; and
said removable storage is selected from a group of storage means consisting of removable flash card, CF, MM, SD, MS, and xD.

14. The wireless smart hard-disk drive according to claim 1, further comprising a multimedia-processing means.

15. The wireless smart hard-disk drive according to claim 1 being a portion of a cellular phone and further comprising a long-range wireless communication means.

16. A wireless multimedia device, comprising:
a multimedia-processing means; and
a wireless direct communication means between said wireless multimedia device and a wireless hard-disk drive.

17. The wireless multimedia device according to claim 16, further comprising a host function or a peer-to-peer function for enabling said direct communication means.

18. The wireless multimedia device according to claim 16, wherein said multimedia-processing means is a recording function and/or a playing function.

19. The wireless multimedia device according to claim 16 being selected from a group of device types consisting of digital still camera, digital camcorder, digital voice recorder, digital audio player, earphone, digital video/movie player, microdisplay-based video/movie display, portable game machine, global positioning system (GPS), personal versatile recorder (PVR), cellular phone, and personal digital assistant (PDA).

20. An interface-conversion apparatus associated with a wired multimedia device, comprising:
a form factor and an interface similar to a removable storage used by said wired multimedia device; and
a communication-conversion means for converting a wired communication between said multimedia device and said removable storage into a wireless communication between said multimedia device and a wireless hard-disk drive.
